(19) United States
(12) Patent Application Publication
(10) Pub. No.: US 2023/0334315 A1
(43) Pub. Date: Oct. 19, 2023

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: KOICHI TANJI, Kanagawa (JP)

(21) Appl. No.: 18/295,679

(22) Filed: Apr. 4, 2023

(30) Foreign Application Priority Data
Apr. 14, 2022 (JP) 2022-066969

(51) Int. Cl. G06N 3/08; G06N 3/04

(52) U.S. Cl. CPC G06N 3/08; G06N 3/04

(57) ABSTRACT

An information processing apparatus which executes a search for an architecture of a network model includes a first learning unit configured to execute learning of an architecture coefficient, a second learning unit configured to execute learning of a weight coefficient, and a control unit configured to execute control to advance the search by causing the first learning unit and the second learning unit to execute learning alternately. The control unit executes control to cause at least any one of the first learning unit and the second learning unit to execute learning on a network model including an architecture coefficient and a weight coefficient acquired at the current point in time using an output value output from a network model set as a teacher model which is configured based on an architecture coefficient and a weight coefficient acquired prior to the current point in time.

### BACKGROUND

### Field

The present disclosure relates to a technique for machine learning.

### Description of the Related Art

In recent years, attention has been given to a technique called “neural architecture search (NAS)” (“A Comprehensive Survey of Neural Architecture Search: Challenges and Solutions”, P. Ren et al. (ACM Comput. Surv., Vol. 37, No. 4, Article 111)) in the field of machine learning. NAS is a technique for determining an architecture of a network through search to acquire higher performance.

The following methods are provided as architecture search methods with NAS. A method with Reinforcement Learning (RL) is described in “Neural Architecture Search with Reinforcement Learning”, B. Zoph et al. (ICLR 2017). In RL, an architecture is generated using a controller recurrent neural network (RNN). The controller RNN is updated and is trained by a policy gradient method using an accuracy (accuracy rate) of the generated architecture as a reward.

A method with Gradient Descent (GD) is described in “DARTS: Differentiable architecture search”, H. Liu et al. (ICLR 2019) and “SNAS: Stochastic neural architecture search”, S. Xie et al. (ICLR 2019). In GD, a space that is searched for an architecture is expressed with a directed acyclic graph (DAG), and the maximum graph expression is set as a parent graph, and a subset of the parent graph is set as a child graph. The subset is a range that is searched for an optimum architecture.

Different from the above-described method with RL in which an operation to be executed at each of layers constituting an architecture is selected discretely, GD uses a continuous expression in which operations are mixed. an architecture is expressed by an expression in which operations (e.g., a convolution operation, a pooling operation, and a zero operation) which are selectable at respective layers are added using a softmax function (“DARTS: Differentiable architecture search”, H. Liu et al. (ICLR 2019)) or a concrete distribution (“SNAS: Stochastic neural architecture search”, S. Xie et al. (ICLR 2019)). Then, an architecture coefficient and a weight coefficient used in the architecture expression are optimized. A validation loss (“DARTS: Differentiable architecture search”, H. Liu et al. (ICLR 2019)) and a generic loss (“SNAS: Stochastic neural architecture search”, S. Xie et al. (ICLR 2019)) are used as loss functions used in the optimization of the architecture expression.

It has been known that an imbalance between learning of an architecture coefficient and learning of a weight coefficient can exist because the number of weight coefficients is overwhelmingly great compared with that of architecture coefficients (“DARTS+: Improved Differentiable Architecture Search with Early Stopping”, H. Liang et al.). This is likely to cause an overfitting state. An overfitting state refers to a state where training error (error in learning data used for learning) deviates from an expected value of generalization error (error in sample population). As techniques for avoiding occurrence of the overfitting state, there are provided a technique called “regularization” which regulates the size of a weight coefficient and a technique called “early stopping” which stops learning when a network is brought into a prescribed state (“DARTS+: Improved Differentiable Architecture Search with Early Stopping”, H. Liang et al.). Further, it is generally known that “distillation learning” as a technique for reducing the size of a network has a regularization effect (“Distilling the Knowledge in a Neural Network”, G. Hinton et al. (NIPS 2014)).

In the course of an architecture search by NAS, an overfitting state and a learning imbalance are likely to occur because learning of a weight coefficient is executed together with learning of an architecture coefficient. As a result, it is difficult to improve the performance of the network. On the other hand, the regularization which regulates the size of the weight coefficient involves empirical setting of a hyper-parameter for controlling the size of the weight coefficient. Further, the method described in “DARTS+: Improved Differentiable Architecture Search with Early Stopping”, H. Liang et al. involves prior setting of an end-of-learning condition. Thus, those techniques lack versatility. Furthermore, distillation learning described in “Distilling the Knowledge in a Neural Network”, G. Hinton et al. (NIPS 2014) has not been used in the course of the architecture search by NAS.

### SUMMARY

The present disclosure is directed to a technique for searching for an architecture with higher performance in the course of an architecture search of a network model.

According to an aspect of the present disclosure, an information processing apparatus which executes a search of a network model including an architecture coefficient and a weight coefficient to determine the architecture of the network model includes at least one memory storing instructions, and at least one processor that, upon execution of the instructions, is configured to execute first learning of an architecture coefficient with a weight coefficient fixed, execute second learning of a weight coefficient with an architecture coefficient fixed, and execute control to advance the search by causing the first learning and the second learning to execute learning alternately on a network model having an architecture coefficient and a weight coefficient acquired at present time using an output value output from a network model set as a teacher model which is configured based on an architecture coefficient and a weight coefficient acquired before the present time.

Further features of the present disclosure will become apparent from the following description of exemplary embodiments with reference to the attached drawings.

### BRIEF DESCRIPTION OF THE DRAWINGS

FIG. 1A is a block diagram illustrating an example of the hardware configuration of an information processing apparatus according to a first exemplary embodiment.

FIG. 1B is a block diagram illustrating an example of the functional configuration of the information processing apparatus according to the first exemplary embodiment.

FIG. 2 is a flowchart illustrating overall processing of an architecture search according to the first exemplary embodiment.

FIGS. 3A and 3B are conceptual diagrams illustrating the architecture search.

FIG. 4 illustrates learning of a network model.

FIGS. 5A to 5C are schematic diagrams illustrating architecture search processing according to the first exemplary embodiment.

FIG. 6 is a graph illustrating an epoch dependency of an accuracy (accuracy rate).

FIG. 7 is a conceptual diagram illustrating distillation learning.

FIGS. 8A to 8C are each a schematic diagram illustrating architecture search processing with the distillation learning.

FIG. 9 is a flowchart illustrating distillation learning processing.

FIG. 10 is a graph illustrating an epoch dependency of an accuracy (accuracy rate).

FIGS. 11A to 11C are each a schematic diagram illustrating architecture search processing according to a second exemplary embodiment.

FIG. 12 is a flowchart illustrating overall processing of an architecture search according to a third exemplary embodiment.

FIG. 13 is a schematic diagram illustrating architecture search processing according to the third exemplary embodiment.

### DESCRIPTION OF THE EMBODIMENTS

Hereinafter, exemplary embodiments according to the present disclosure will be described with reference to the appended drawings. Configurations described in the below-described exemplary embodiments are merely examples, and the present disclosure is not limited to the configurations described below.

In a first exemplary embodiment, optimization of a network model is executed with a technique of the neural architecture search (NAS).

A hierarchical network such as a neural network is assumed as a network model. In NAS, a search for an architecture (i.e., a type of operation executed at each layer and a connection state of layers) of the hierarchical network is executed in order to acquire higher performance. Further, in the course of an architecture search, learning is executed with respect to a weight coefficient and the other parameters for the architecture searched for.

In the present exemplary embodiment, a method for using distillation learning in the course of the architecture search will be described. Distillation learning is typically performed using a smaller student model that uses output values of a large teacher model with high accuracy as teacher data (called “soft target”), and using an error (also called “soft target error”) between each output value and the soft target. Herein, for example, a soft target is an output value which can be acquired by using a softmax-with-temperature function as an activating function at an output layer. A softmax-with-temperature function has a property that, with a rise in temperature, an output value of a class corresponding to a correct class becomes smaller whereas the output values of the other classes become greater. In comparison with the case where normal teacher data (called “hard target”) is used in learning, the output values (information) of the classes other than the correct class make contributions to learning. Further, a soft target error refers to an error calculated from a soft target and an output value of a student model. Generally, a teacher model, which outputs a soft target when learning of the student model is executed, is a model larger than the student model, and has a higher accuracy than that of the student model. Further, generally, a student model is a model smaller than a teacher model, and is trained with a soft target error. Although a trained model used as a teacher model is used for distillation learning, distillation learning is advantageous in that a small-sized model having high accuracy can be acquired, and in that a model less likely to cause an overfitting state can be acquired because of the regularization effects, i.e., an effect of eliminating deviation in magnitude of the weight coefficient.

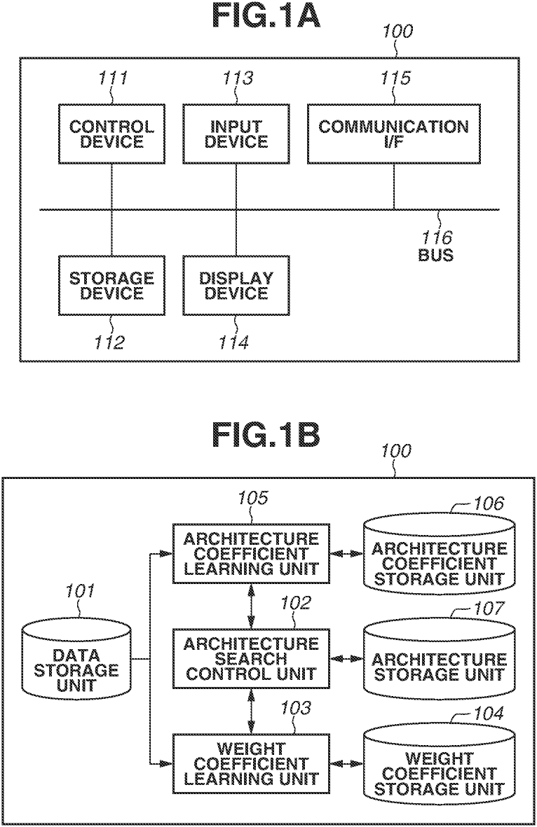

FIG. 1A is a block diagram illustrating an example of the hardware configuration of an information processing apparatus according to the present exemplary embodiment. An information processing apparatus 100 according to the present exemplary embodiment includes a control device 111, a storage device 112, an input device 113, a display device 114, and a communication interface (I/F) 115. These devices are connected to one another via a bus 116. The control device 111 includes a central processing unit (CPU) and a graphic processing unit (GPU), and performs general controls of the information processing apparatus 100. The control device 111 functions as a calculator for executing the NAS. The storage device 112 includes a hard disk, and stores programs used for the control device 111 to execute operations, data used for various types of processing, and data acquired as execution results of various types of processing.

The input device 113 is a human interface device which allows a user to input operating information to the information processing apparatus 100. The display device 114 is a display which displays an execution result of processing according to the present exemplary embodiment under the control of the control device 111. The communication I/F 115 connects to an external device through wired or wireless communication, and exchanges data with the external device under the control of the control device 111.

Further, the present exemplary embodiment is not limited to the configuration illustrated in FIG. 1A, in which the storage device 112, the input device 113, and the display device 114 are arranged inside a housing of the information processing apparatus 100. The input device 113 and the display device 114 may be external devices connected thereto via the communication I/F 115 or an input/output I/F (not illustrated). Similarly, the storage device 112 may be an external data storage device connected thereto via the communication I/F 115 or the input/output I/F (not illustrated).

FIG. 1B is a block diagram illustrating an example of the functional configuration of the information processing apparatus 100 according to the present exemplary embodiment. The information processing apparatus 100 includes an architecture search control unit 102, a weight coefficient learning unit 103, and an architecture coefficient learning unit 105. The control device 111 runs programs stored in the storage device 112 to cause the above-described respective functional units to work. Further, a data storage unit 101 for storing learning data and validation data, a weight coefficient storage unit 104, an architecture coefficient storage unit 106, and an architecture storage unit 107 are stored in the storage device 112 of the information processing apparatus 100.

The architecture search control unit 102 reads out the learning data and the validation data stored in the data storage unit 101, and executes control to search for an optimum architecture. Further, the architecture search control unit 102 stores information about an eventually acquired architecture (architecture coefficient) in the architecture storage unit 107. Furthermore, the architecture search control unit 102 calculates a validation accuracy (i.e., an accuracy rate of the validation data, hereinafter, also called “val_acc”) of a network acquired in the course of a search by using the validation data.

The weight coefficient learning unit 103 executes learning of a weight coefficient corresponding to an operation executed at each layer by using data read by the architecture search control unit 102. The weight coefficient storage unit 104 stores temporary weight coefficients acquired in the course of the architecture search in chronological order.

The architecture coefficient learning unit 105 executes learning of an architecture coefficient used for expressing the architecture by using data read by the architecture search control unit 102. The architecture expression will be described below. The architecture coefficient storage unit 106 stores temporary architecture coefficients acquired in the course of the architecture search in chronological order.

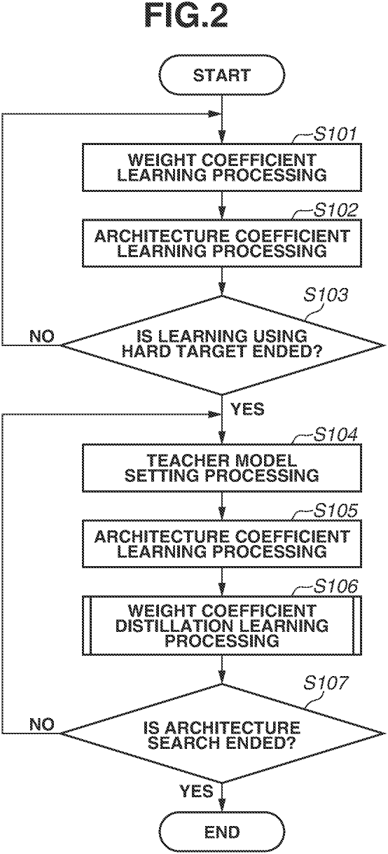

The overall processing of the architecture search executed by the information processing apparatus 100 according to the present exemplary embodiment will now be described. FIG. 2 is a flowchart illustrating the overall processing of the architecture search according to the present exemplary embodiment. In the flowchart described below, each step (processing) is expressed by a reference numeral prefixed with a symbol “S”, and notation of a step (processing) is omitted. The processing in respective steps illustrated in the flowchart is implemented by the control device 111 by running programs stored in the storage device 112.

In steps S101 and S102, the architecture search control unit 102 reads appropriate learning data from the data storage unit 101 and controls the operation of the weight coefficient learning unit 103 and the architecture coefficient learning unit 105. In step S101, the weight coefficient learning unit 103 executes learning of a weight coefficient by using the learning data. In step S102, the architecture coefficient learning unit 105 executes learning of an architecture coefficient by using the learning data. In the architecture search according to the present exemplary embodiment, the architecture search control unit 102 executes control to cause the weight coefficient learning unit 103 and the architecture coefficient learning unit 105 to operate alternately. In steps S101 and S102, learning is executed by using the learning data consisting of input data and teacher data. An architecture coefficient and a weight coefficient are updated by inputting the input data to a target network and back propagating an error of the output value acquired as a result of forward propagation calculation in the target network. The teacher data (hard target) is used for calculating the above-described error of the output value. The teacher data is data which describes a desirable output (a label value or a distribution of label values) for the input data.

Hereinafter, the processing executed in steps S101 and S102 will be described in detail. In order to schematically describe the processing, an architecture coefficient is expressed as “α”, and a weight coefficient is expressed as “w”. Further, a loss (training loss) calculated by using the learning data is expressed as “Lₜᵣₐᵢₙ”. Furthermore, a loss (validation loss) calculated by using the validation data is expressed as “Lᵥₐₗ”. The losses Lₜᵣₐᵢₙ and Lᵥₐₗ are determined by the coefficients α and w. In the architecture search, a pair of coefficients α and w which minimizes the losses Lₜᵣₐᵢₙ and Lᵥₐₗ is searched for, as expressed by the following formula 1.

$${min}_{α} {L}_{v a l} \left(w \text{*} \left(α\right) , α\right) s . t w \text{*} \left(α\right) = {\text{argmin}}_{w} {L}_{t r a i n} \left(w , α\right) \qquad \text{(1)}$$

In step S101, the weight coefficient learning unit 103 executes learning of the weight coefficient w by using the learning data read by the architecture search control unit 102 on the network including the architecture coefficient and the weight coefficient updated through the previous learning. Specifically, the weight coefficient w is updated by calculating a gradient of the training loss Lₜᵣₐᵢₙ through the following formula 2. Herein, the processing is similar to the processing for updating a weight coefficient executed in the normal neural network learning. The weight coefficient storage unit 104 stores the updated weight coefficient w. The weight coefficient storage unit 104 stores a weight coefficient every time the weight coefficient is updated. Therefore, the weight coefficients are retained in chronological order.

$${\text{V}}_{\text{w}} {L}_{t r a i n} \left(w , a\right) \qquad \text{(2)}$$

In step S102, the architecture coefficient learning unit 105 executes a search (learning) for an optimum architecture expression by using the read learning data. In a case where a network as a search target is expressed by a connection state of a plurality of contact points (hereinafter, called “nodes”) and operations executed between the nodes, the architecture is expressed by weighting and adding all of the operations which can be executed at the respective nodes. Nodes are an example of elements which are included in a network. Hereinafter, the present exemplary embodiment will be described with respect to a case where a search for a CELL structure consisting of four nodes is executed by using the GD method (“DARTS: Differentiable architecture search”, H. Liu et al. (ICLR 2019), “SNAS: Stochastic neural architecture search”, S. Xie Et al. (ICLR 2019)), on the assumption that four operations O (zero operations o¹, o², o³, and 0) are executed. A zero operation is an operation involved in a connection state of nodes. When a value thereof is 1, the operation expresses a state where the connection between the nodes is disconnected. A CELL structure is a unit structure which constitutes an architecture of the entire network.

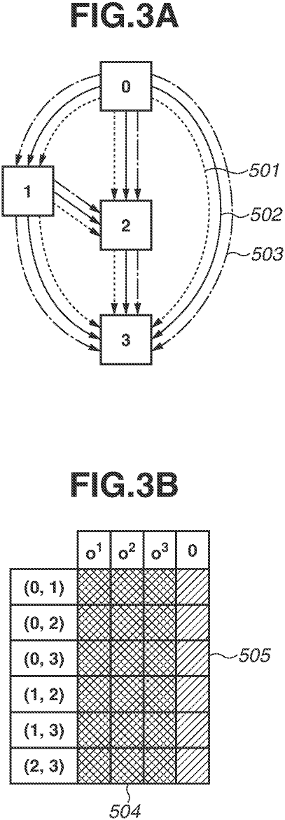

FIG. 3A illustrates a CELL structure as a search target in the present exemplary embodiment. The example in FIG. 3A illustrates a network graph assuming four nodes affixed with node numbers 0 to 3 and four operations. Each of the edges which connects the nodes expresses a connection relationship between the nodes. A dashed line 501 expresses an operation o¹, a solid line 502 expresses an operation o², and a dashed-dotted line 503 expresses an operation o³. Information x^{(j)} retained in a node j is expressed by the following formula 3 by using an output x⁽ⁱ⁾ from a previous node i and an operation o ^{(i, j)} between nodes. In a convolutional neural network (CNN), for example, information about a feature map is retained in each node.

$${x}^{\left(j\right)} = {\sum }_{i < j} {o}^{\left(i , j\right)} \left({x}^{\left(i\right)}\right) \qquad \text{(3)}$$

In the above, the letters “i” and “j” represent node numbers.

For example, the operation o ^{(i,} ^{j)} performed between the nodes in the above-described formula 3 can be expressed by a continuous expression in which respective operations are mixed as illustrated in the following formula 4 by adding the operations o¹, o², and o³ through a softmax function, instead of being expressed by a discrete expression of the operations.

$${\overline{o}}^{\left(i , j\right)} \left(x\right) = {\sum }_{o ∈ O} \frac{exp \left({α}_{o}^{\left(i , j\right)}\right)}{{\sum }_{{o}^{′} ∈ O} exp \left({α}_{{o}^{′}}^{\left(l , j\right)}\right)} o \left(x\right) \qquad \text{(4)}$$

In the above formula 4, “α^{(i,j)}” represents a vector which expresses weighting of each operation, and ″αₒ^{(i,j)}″represents a component thereof. As illustrated in the following formula 5, the operation performed between the nodes is expressed by a set of α^{(i,j).}

$$\overline{α} = \left\{{α}^{\left(i , j\right)}\right\} \qquad \text{(5)}$$

FIG. 3B is a schematic diagram of the CELL structure in FIG. 3A expressed by a matrix including a set of α^{(i,j)} expressed by the above formula 5 and zero operations. A shaded area 504 with cross hatched lines illustrates weighting of the operations o¹,o², and o³ at connections between nodes ((0, 1) (0, 2) (0, 3) (1, 2) (1, 3) (2, 3)), and a shaded area 505 with hatched lines illustrates a value of the zero operation corresponding to a connection state between the nodes. A connected state and a disconnected state of nodes are expressed by values of 0 to 1 of the zero operation. As described above, by employing the continuous expression, a space where a search (learning) is executed with respect to the operations can be a continuous space, making it possible to use a gradient method when the search (learning) is executed.

In step S102, the architecture coefficient learning unit 105 executes learning of an architecture coefficient α by using the learning data read by the architecture search control unit 102 on the network including the architecture coefficient and the weight coefficient updated through the previous learning. Specifically, the architecture coefficient learning unit 105 calculates a gradient of the validation loss Lᵥₐₗ and updates the architecture coefficient α through the following formula 6. The architecture coefficient learning unit 105 stores the updated architecture coefficient α. The architecture coefficient storage unit 106 stores the architecture coefficient every time the architecture coefficient is updated. Thus, the architecture coefficients are retained in chronological order.

$${V}_{u} {L}_{v a l} \left(w \text{*} \left(α\right) , α\right) \qquad \text{(6)}$$

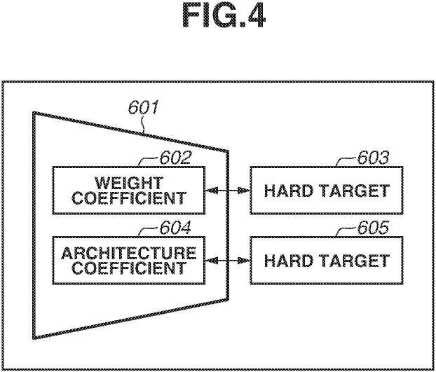

The network model learned in steps S101 and S102 will now be described with reference to FIG. 4. In the present exemplary embodiment, a network model 601 includes a weight coefficient 602 and an architecture coefficient 604. The weight coefficient 602 and the architecture coefficient 604 are learned by respectively using hard targets 603 and 605 as teacher data. In addition, the hard targets 603 and 605 may be set such that teacher data in the same learning data set or a different learning data set is used.

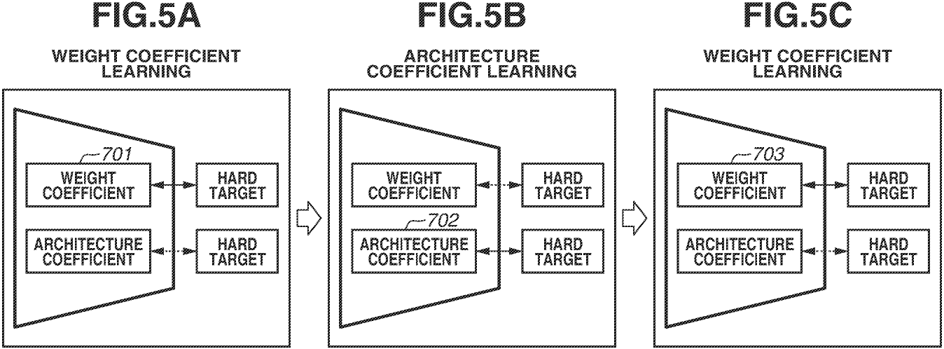

FIGS. 5A to 5C schematically illustrate the processing for advancing the architecture search by alternately executing learning of a weight coefficient and learning of an architecture coefficient. The processing for alternately executing learning (optimization) is called “bi-level optimization”. FIG. 5A illustrates a state where learning of a weight coefficient 701 is executed with an architecture coefficient fixed. FIG. 5B illustrates a state where learning of an architecture coefficient 702 is executed with a weight coefficient fixed. FIG. 5C illustrates a state where learning of a weight coefficient 703 is executed with an architecture coefficient fixed again through a subsequent step of the bi-level optimization.

In step S103, the architecture search control unit 102 determines whether learning using a hard target is to be ended. The architecture search control unit 102 may determine whether the number of times of learning has reached a prescribed number, whether the performance at a certain level or higher is acquired by using the validation data, or whether a loss has become a predetermined value or less. When the architecture search control unit 102 determines that learning using a hard target is to be ended (YES in step S103), the processing proceeds to step S104. If the architecture search control unit 102 determines that learning using a hard target is executed continuously (NO in step S103), the processing in steps S101 and S102 is executed repeatedly.

Herein, the number of weight coefficients is overwhelmingly great compared with the number of architecture coefficients, both of which are included in the network model. This can cause imbalance of learning in the bi-level optimization (“DARTS+: Improved Differentiable Architecture Search with Early Stopping”, H. Liang et al.). For example, the weight coefficients which are large in number may fall into the overfitting state more easily, or imbalance may occur between a learning degree of the architecture coefficient and a learning degree of the weight coefficient. As a result, as the search progresses, the performance of the architecture eventually acquired in the course of the conventional architecture search by NAS can be degraded.

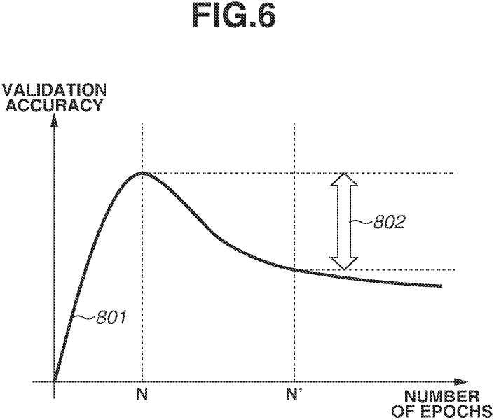

FIG. 6 is a graph illustrating an epoch dependency of an accuracy (accuracy rate) in the course of the conventional architecture search. The horizontal axis of the graph in FIG. 6 illustrates the number of epochs, and the vertical axis thereof represents a validation accuracy val_acc. The number of epochs represents the number of times a set of learning data is learned repeatedly. A data curve 801 illustrates a state where the validation accuracy val_acc reaches a maximum value when the number of epochs is N, and is subsequently lowered (performance is degraded) by an amount corresponding to a width 802 when the number of epochs is N′. As illustrated in FIG. 6, as the search progresses, the performance of the architecture eventually acquired in the course of the conventional architecture search is degraded.

Conventionally, a technique called “regularization”, which regulates the size of the weight coefficient, has been employed as a technique for avoiding degradation of performance caused by overfitting. However, the effect of the conventional regularization tends to highly depend on parameters for controlling the effect. In the present exemplary embodiment, while attention is focused on a regularization effect of distillation learning, a method for applying distillation learning in the course of the architecture search by NAS will be described.

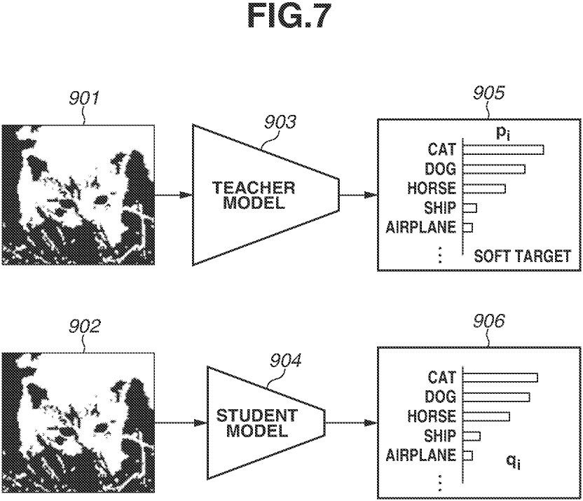

First, distillation learning and its regularization effect will be described with reference to FIG. 7.

A diagram on the upper side of FIG. 7 illustrates distillation learning executed by using a teacher model 903, and a diagram on the lower side of FIG. 7 illustrates distillation learning executed by using a student model 904. An image 901 is learning data (input data about an image) input to the teacher model 903. An image 902 is learning data (input data about an image) input to the student model 904. Images of a cat are provided as the examples of the images 901 and 902. Generally, a model larger than the student model 904 is used as the teacher model 903. On the other hand, generally, in order to reduce implementation cost and operation cost of inference, a smaller model is used as the student model 904.

Hereinafter, distillation learning will be described with respect to a case where a softmax-with-temperature function is used as an activating function of output layers at the teacher model 903 and the student model 904. A distribution 905 illustrates a distribution of output values pi (soft target) acquired by inputting the data about the image 901 to the teacher model 903. Herein, a letter “i” represents a number allocated to each of classes. In a case where the softmax-with-temperature function is used as the activating function, a distribution of output values has characteristics in which an output value of a class corresponding to a correct class (herein, a value corresponding to “cat”) is close to 1, whereas output values of the other classes are close to 0. Herein, “softmax_i”, an output value corresponding to the i-th class, can be expressed by the following formula 7 with the softmax function. In addition, a letter “j” in the following formula 7 takes a value within a range of 1 to N when the total number of classes is N.

$$s o f t m a x \text{\_} i = \frac{e x p \left({u}_{i}\right)}{{\sum }_{j} e x p \left({u}_{j}\right)} \qquad \text{(7)}$$

In the above, respective symbols represent the following.

ui: an input value corresponding to the i-th class, input to the softmax function.

uj: an input value corresponding to the j-th class, input to the softmax function.

However, because the activating function such as the softmax-with-temperature function which provides a smoother distribution of output values is used for distillation learning, an output value other than an output value of a class corresponding to the correct class (i.e., a value corresponding to “cat”) also becomes relatively large. Herein, “T_softmax_i”, an output value corresponding to the i-th class, can be expressed by the following formula 8 with the softmax-with-temperature function with a setting temperature T (T> 1). In addition, a letter “j” in the following formula 8 takes a value within a range of 1 to N when the total number of classes is N.

$$T \text{\_} s o f t m a x \text{\_} i = \frac{e x p \left({u}_{i} / T\right)}{{\sum }_{j} e x p \left({u}_{j} / T\right)} \qquad \text{(8)}$$

In the above, respective symbols represent the following.

ui: an input value corresponding to the i-th class, input to the softmax-with-temperature function.

uj: an input value corresponding to the j-th class, input to the softmax-with-temperature function.

The output values, i.e., the distribution of output values pi, of the softmax-with-temperature function include the information about a class corresponding to the correct class and the information about similarity between a class other than the correct class and the correct class. These output values (information) make contributions to learning. Thus, parameters including the weight coefficient are updated evenly, producing a regularization effect, i.e., an effect of eliminating deviation in magnitude of the weight coefficient. In this case, although the temperature T is set as a setting parameter, changes in the effect of distillation learning are relatively moderate as long as the temperature T falls within a certain range of setting temperatures, which eliminates the need to perform a strict control of the temperature T.

A distribution 906 illustrates a distribution of output values qi acquired by inputting data about the image 902 to the student model 904. Herein, a letter “i” represents a number allocated to each of classes. Generally, in a case where the softmax-with-temperature function is used as the activating function of the teacher model and the student model, a temperature the same as the temperature applied to the teacher model is applied to the student model. As illustrated in the following formula 9, in the distillation learning, a soft target loss (soft_tarted_loss) is calculated from the output value pi of the teacher model 903 and the output value qi of the student model 904. In addition, a letter “i” in the following formula 9 takes a value within a range of 1 to N when the total number of classes is N.

$$s o f t \text{\_} t a r g e t \_ l o s s = - {\sum }_{i} {p}_{i} log \left({q}_{i}\right) \qquad \text{(9)}$$

The output value qi of the student model 904 in the above formula 9 is calculated with the following formula 10. In addition, a letter “j” in the following formula 10 takes a value within a range of 1 to N when the total number of classes is N.

$${q}_{i} = \frac{e x p \left({v}_{i} / T\right)}{{\sum }_{j} e x p \left({v}_{j} / T\right)} \qquad \text{(10)}$$

In the above, respective symbols represent the following.

vi: an input value corresponding to the i-th class, input to the softmax-with-temperature function.

vj: an input value corresponding to the j-th class, input to the softmax-with-temperature function. As described above, learning of the student model 904 is executed based on a soft target loss calculated from the output value pi of the teacher model 903 and the output value qi of the student model 904.

The above-described distillation learning is executed based on the assumption that a teacher model exists in advance. However, in the course of architecture search by NAS, a teacher model does not exist in advance. In the present exemplary embodiment, a network model acquired through learning executed earlier than the last time is retained, and this retained network model is used as a teacher model for the distillation learning executed at the current point in time in bi-level optimization.

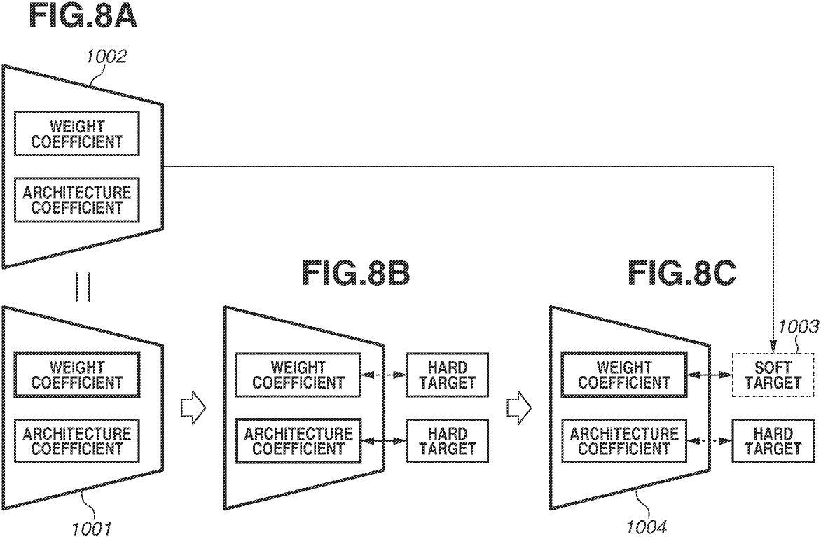

FIGS. 8A to 8B schematically illustrate the architecture search using distillation learning. FIG. 8A illustrates a state where a network model 1002 used as a teacher model is set by copying a network model 1001 acquired at the current point of time. FIG. 8B illustrates a state where learning of an architecture coefficient is executed by using a hard target with a weight coefficient of the network model 1001 fixed. This learning is called “first learning”. In other words, the network model 1002 is a network model which includes a weight coefficient and an architecture coefficient acquired immediately before the first learning. FIG. 8C illustrates a state where learning of a weight coefficient is executed by using an output value output from the network model 1002 (teacher model) as a soft target 1003, on a network model 1004 fixed with the architecture coefficient acquired through the first learning.

The processing in step S104 and subsequent steps illustrated in the flowchart in FIG. 2 will now be described with reference to FIG. 8.

Before the processing in step S104 is started, firstly, the architecture search control unit 102 reads learning data used for the next search (steps S105 and S106) from the data storage unit 101.

In step S104, the architecture search control unit 102 sets a teacher model for distillation learning. Herein, the network model 1001 which includes the weight coefficient and the architecture coefficient acquired at the current point in time is set to the network model 1002 used as a teacher model for distillation learning. In addition, the weight coefficient and the architecture coefficient acquired at the current point in time are updated through the previous processing in steps S101 and S102 or the processing in steps S105 and S106. The weight coefficients and the architecture coefficients updated in the course of the search are respectively stored in the weight coefficient storage unit 104 and the architecture coefficient storage unit 106 in chronological order. Thus, the architecture search control unit 102 sets the network model 1002 as a teacher model by using the latest data read from the weight coefficient storage unit 104 and the architecture coefficient storage unit 106. In the present exemplary embodiment, although the network model 1002 is set using the latest data, the network model 1002 may be set using the data acquired in the past. In other words, either the weight coefficient and the architecture coefficient acquired immediately before the previous leaning or the weight coefficient and the architecture coefficient acquired earlier than the previous time can be used as the teacher model.

In step S105, the architecture coefficient learning unit 105 executes learning on the network model 1001 and updates the architecture coefficient. This processing is similar to the processing in step S102.

Herein, learning is executed using teacher data (hard target).

In step S106, the weight coefficient learning unit 103 mainly executes distillation learning of the weight coefficient with the architecture coefficient updated in step S105 fixed.

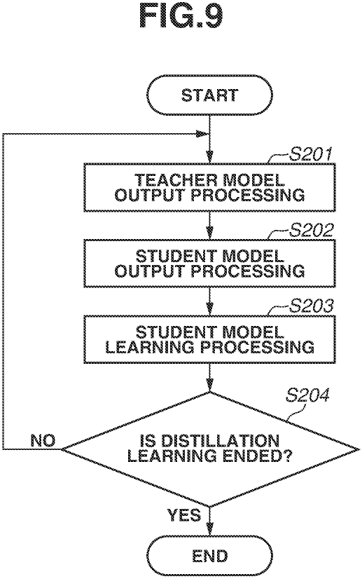

Hereinafter, the distillation learning processing of a weight coefficient executed in step S105 will now be described with reference to the flowchart in FIG. 9.

First, in step S201, the architecture search control unit 102 inputs input data to the network model 1002 set in step S104 and acquires an output value. This output value is used as a soft target 1003.

In step S202, the weight coefficient learning unit 103 inputs the input data to the network model 1004 including the architecture coefficient updated in step S105 and acquires an output value.

In step S203, the weight coefficient learning unit 103 calculates a soft target loss from the soft target 1003 acquired in step S201 and the output value acquired in step S202. Then, the weight coefficient learning unit 103 executes the distillation learning of the weight coefficient using the calculated soft target loss.

In step S204, the architecture search control unit 102 determines whether to end the distillation learning of the weight coefficient. In the present exemplary embodiment, the architecture search control unit 102 determines whether the number of times of learning has reached to a prescribed number. If the architecture search control unit 102 determines that the distillation learning of the weight coefficient is ended (YES in step S204), the weight coefficient is updated with a value acquired from the learning. Then, the processing proceeds to step S107. If the architecture search control unit 102 determines that the distillation learning of the weight coefficient is executed continuously (NO in step S204), the processing in steps S201 to S203 is executed repeatedly.

In step S107, the architecture search control unit 102 determines whether to end the architecture search. In the present exemplary embodiment, the architecture search control unit 102 determines whether the number of times of learning has reached to a prescribed number. In order to make the above determination, the architecture search control unit 102 may also determine whether the performance at a certain level or more is acquired using the validation data or whether a loss value has become a certain value or less. If the architecture search control unit 102 determines that the architecture search is ended (YES in step S 107), the architecture coefficient acquired through the learning is stored in the architecture storage unit 107. Then, a series of processing is ended. If the architecture search control unit 102 determines that architecture search is executed continuously (NO in step S107), the processing in steps S104 to S106 is executed repeatedly.

According to the above-described exemplary embodiment, the use of the network model acquired immediately before the previous learning as a teacher model for learning executed at the current point in time allows distillation learning to be employed in the course of architecture search by NAS. This causes parameters including the weight coefficient to be updated evenly, producing a regularization effect, i.e., an effect of eliminating deviation in magnitude of the weight coefficient. In other words, learning of the architecture coefficient and the weight coefficient is executed and advanced in a balanced manner, which is unlikely to cause an overfitting state, enabling search for an architecture with higher performance.

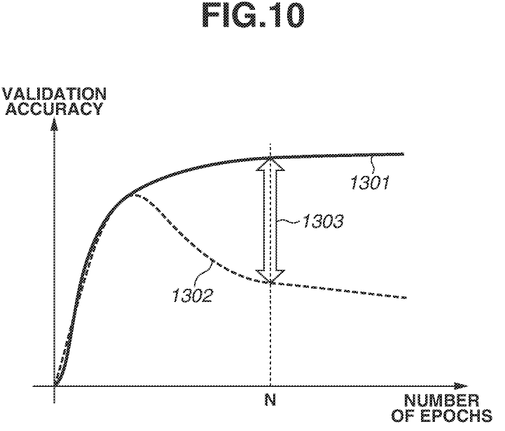

The above-described effect according to the present exemplary embodiment will be described with reference to FIG. 10. FIG. 10 is a graph illustrating an epoch dependency of an accuracy (accuracy rate). The horizontal axis of the graph in FIG. 10 illustrates the number of epochs, and the vertical axis thereof illustrates the validation accuracy val_acc. A data curve 1301 illustrates the epoch dependency of an accuracy (accuracy rate) in the course of the architecture search according to the present exemplary embodiment. A data curve 1302 illustrates the epoch dependency of an accuracy (accuracy rate) in the course of the conventional architecture search. A difference 1303 illustrates a difference between the validation accuracy val_acc of the architecture searched by the conventional method and the validation accuracy val_acc of the architecture searched by the present method. As illustrated in FIG. 10, as the search progresses, the performance of the architecture eventually acquired in the course of the conventional architecture search is degraded. However, such degradation does not occur in the course of the architecture search according to the present exemplary embodiment.

As a modification example of the present exemplary embodiment, the information processing apparatus 100 may sequentially and repeatedly execute the processing in steps S101 to S106. In other words, after executing the processing in step S106, the information processing apparatus 100 may execute the architecture search using a hard target by advancing the processing to steps S101 to S103 again.

A second exemplary embodiment will be described. In the first exemplary embodiment, in the course of architecture search in which learning of an architecture coefficient and a weight coefficient is executed alternately, distillation learning is executed by using a network model acquired immediately before the last learning as a teacher model for learning executed at the current point in time. In the present exemplary embodiment, a case will be described in which the first to the Nth searches are executed in parallel, and an ensemble of network models acquired in the course of the first to the Nth searches is acquired, and this ensemble is used as a teacher model for the N+1th search. Differences from the first exemplary embodiment will be mainly described, and descriptions of the configuration common to that in the first exemplary embodiment will be omitted.

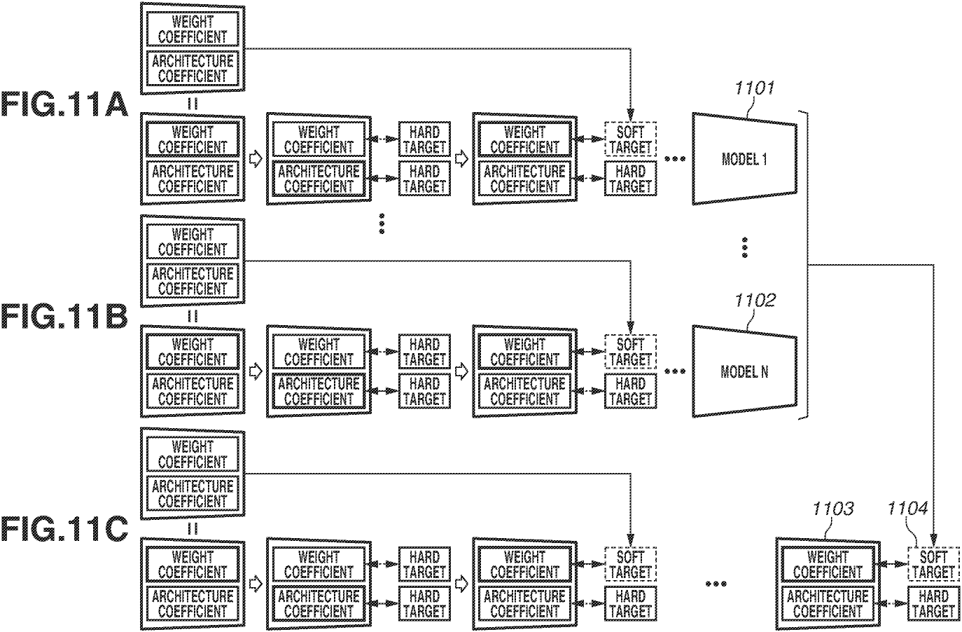

FIG. 11 schematically illustrates architecture search according to the present exemplary embodiment.

FIG. 11A schematically illustrates a state where a model 1, illustrated as a network model 1101, is acquired in the course of the first architecture search. The first architecture search is executed in a similar way to the search described in the first exemplary embodiment in FIG. 8. In the first architecture search, through the control executed by the architecture search control unit 102, learning of an architecture coefficient using a hard target and learning of a weight coefficient using a soft target are executed alternately. The weight coefficient and the architecture coefficient acquired in the course of the first architecture search are respectively stored in the weight coefficient storage unit 104 and the architecture coefficient storage unit 106.

FIG. 11B schematically illustrates a state where a model N, illustrated as a network model 1102, is acquired in the course of the Nth architecture search. In the Nth architecture search, after the processing similar to the processing described in the first exemplary embodiment in FIG. 8 is executed, learning of the weight coefficient using a hard target is executed again. The weight coefficient and the architecture coefficient acquired in the course of the Nth architecture search are respectively stored in the weight coefficient storage unit 104 and the architecture coefficient storage unit 106. The weight coefficients and the architecture coefficients acquired in the course of the first to the Nth architecture searches are respectively stored in the weight coefficient storage unit 104 and the architecture coefficient storage unit 106. The first to the Nth architecture searches are different from one another. The searches can be differentiated from one another by repeatedly executing the above-described alternate learning a plurality of times, or by repeatedly executing learning using a hard target in the middle of the alternate learning.

FIG. 11C schematically illustrates a state where a network model 1103 is acquired in the course of the N+1th architecture search. First, through the control executed by the architecture search control unit 102, a network model 1103 prior to execution of distillation learning is acquired by executing learning of an architecture coefficient using a hard target and learning of a weight coefficient using a soft target. Thereafter, the architecture search control unit 102 sets an ensemble of the N models, the model 1 to the model N, (for the simplest example, a simple average), as a teacher model, and sets an output value output from the set teacher model as a soft target 1104. The ensemble of the N models can be acquired by taking a simple average of the N models. Specifically, the architecture search control unit 102 acquires weight coefficients and architecture coefficients acquired in the course of the first to the Nth searches from the weight coefficient storage unit 104 and the architecture coefficient storage unit 106, and calculates parameters included in the teacher model based on the acquired coefficients. By acquiring the teacher model from the ensemble of the N models, the performance of the teacher model can be improved compared with the case where a single model is used. Thereafter, the weight coefficient learning unit 103 calculates a soft target loss from the output value outputs from the network model 1103 and the soft target 1104, and executes distillation learning of the weight coefficient.

In addition, the architecture search control unit 102 may execute control to hierarchically and repeatedly execute the entire search illustrated in FIG. 11 a plurality of times. In other words, the architecture search control unit 102 may acquire M models by repeatedly executing the processing for eventually acquiring the network model 1103 M times, to use the ensemble of the M models as a teacher model for the M+1th architecture search.

As described above, according to the present exemplary embodiment, the use of the ensemble of a plurality of network models acquired in the course of different searches provides a teacher model with higher performance. Executing distillation learning using the above-described teacher model allows search for an architecture with higher performance.

A third exemplary embodiment will be described. In the first exemplary embodiment, distillation learning is executed on the weight coefficient alone. In the present exemplary embodiment, distillation learning is executed on both a weight coefficient and an architecture coefficient.

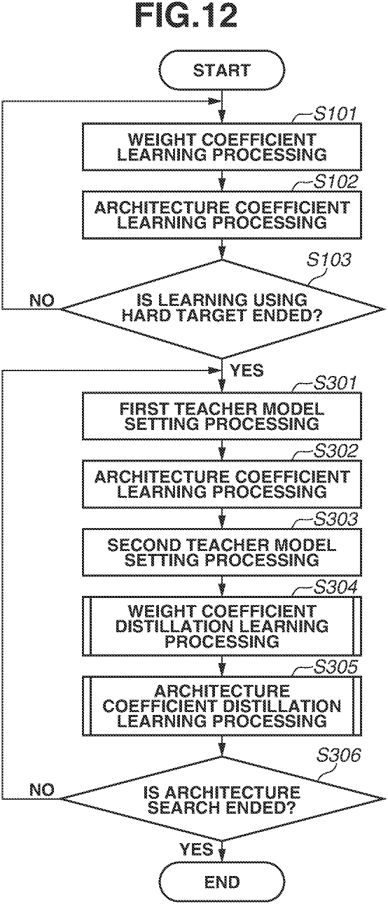

FIG. 12 is a flowchart illustrating the overall processing of an architecture search executed by the information processing apparatus 100 according to the present exemplary embodiment. The processing in steps S101 to S103 in FIG. 12 is similar to the processing in steps S101 to S103 in FIG. 2, so that the descriptions thereof will be omitted.

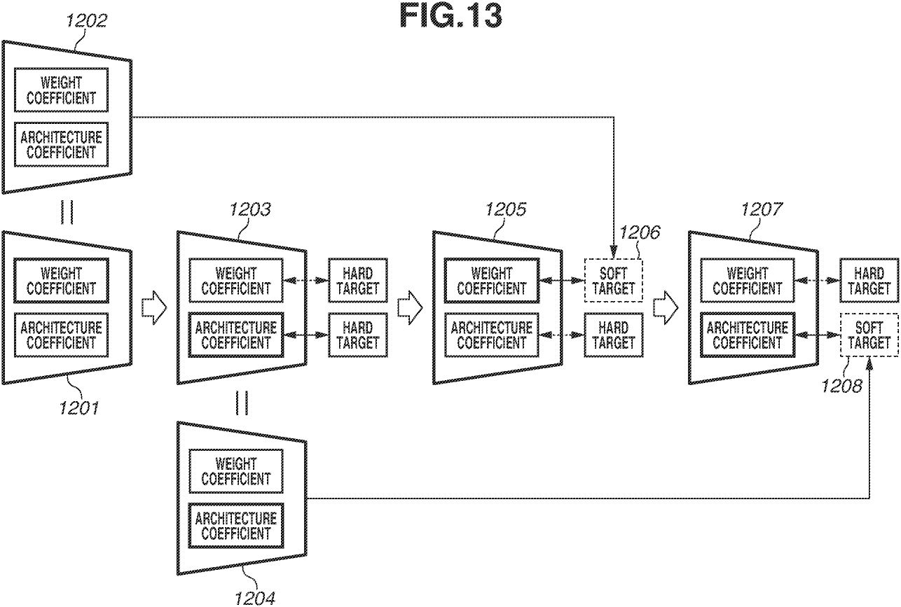

FIG. 13 schematically illustrates the architecture search according to the present exemplary embodiment. First, a network model 1202 used as a first teacher model is set by copying a network model 1201 acquired at the current point in time. Next, learning of an architecture coefficient is executed by using a hard target on a network model 1203 fixed with the weight coefficient of the network model 1201. This learning is called “first learning”. In other words, the network model 1202 is a network model which includes a weight coefficient and an architecture coefficient acquired immediately before the first learning.

Next, a network model 1204 used as a second teacher model is set by copying the network model 1203 including the architecture coefficient acquired through the first learning. Next, learning of a weight coefficient is executed using an output value output from the network model 1202 (i.e., first teacher model) as a soft target 1206, on a network model 1205 fixed with the architecture coefficient acquired through the first learning. This learning is called “second learning”.

Next, learning of an architecture coefficient is executed using an output value output from the network model 1204 (i.e., second teacher model) as a soft target 1208, on a network model 1207 fixed with the weight coefficient acquired through the second learning. This learning is called “third learning”.

Before the processing in step S301 is started, firstly, the architecture search control unit 102 reads learning data used in the next search (steps S301 to S305) from the data storage unit 101.

In step S301, the architecture search control unit 102 executes setting of the teacher model for distillation learning. Herein, the network model 1201 which includes the weight coefficient and the architecture coefficient acquired at the current point in time is set to the network model 1202 used as a first teacher model for distillation learning of the weight coefficient.

In step S302, the architecture coefficient learning unit 105 executes learning on the network model 1201 and updates the architecture coefficient. This processing is similar to the processing in step S102. Herein, learning is executed with using teacher data (hard target).

In step S303, the architecture search control unit 102 executes setting of the teacher model for distillation learning. Herein, the network model 1203 which includes the weight coefficient and the architecture coefficient acquired at the current point in time is set to the network model 1204 used as a second teacher model for distillation learning of the architecture coefficient.

In step S304, the weight coefficient learning unit 103 mainly executes distillation learning of the weight coefficient with the architecture coefficient updated in step S302 fixed. Hereinafter, the distillation learning processing of a weight coefficient executed in step S304 will be described with reference to the flowchart in FIG. 9.

First, in step S201, the architecture search control unit 102 inputs input data to the network model 1202 (first teacher model) set in step S301 and acquires an output value. This output value is used as a soft target 1206.

In step S202, the weight coefficient learning unit 103 inputs the input data to the network model 1205 including the architecture coefficient updated in step S302 and acquires an output value.

In step S203, the weight coefficient learning unit 103 calculates a soft target loss from the soft target 1206 acquired in step S201 and the output value acquired in step S202. Then, the weight coefficient learning unit 103 executes the distillation learning of the weight coefficient using the calculated soft target loss.

In step S204, the architecture search control unit 102 determines whether to end the distillation learning of the weight coefficient. If the architecture search control unit 102 determines that the distillation learning of the weight coefficient is ended (YES in step S204), the weight coefficient is updated with a value acquired from the learning. Then, the processing proceeds to step S305. If the architecture search control unit 102 determines that distillation learning of the weight coefficient is executed continuously (NO in step S204), the processing in steps S201 to S203 is executed repeatedly.

In step S305, the architecture coefficient learning unit 105 mainly executes distillation learning of an architecture coefficient with the weight coefficient updated in step S304 fixed. Hereinafter, the distillation learning processing of an architecture coefficient executed in step S305 will be described with reference to the flowchart in FIG. 9.

First, in step S201, the architecture search control unit 102 inputs input data to the network model 1204 (first teacher model) set in step S303 and acquires an output value. This output value is used as a soft target 1208.

In step S202, the architecture coefficient learning unit 105 inputs the input data to the network model 1207 including the weight coefficient updated in step S304 and acquires an output value.

In step S203, the architecture coefficient learning unit 105 calculates a soft target loss from the soft target 1208 acquired in step S201 and the output value acquired in step S202. Then, the architecture coefficient learning unit 105 executes the distillation learning of the architecture coefficient using the calculated soft target loss.

In step S204, the architecture search control unit 102 determines whether to end the distillation learning of the architecture coefficient. If the architecture search control unit 102 determines that the distillation learning of the architecture coefficient is ended (YES in step S204), the weight coefficient is updated by a value acquired from the learning. Then, the processing proceeds to step S305. If the architecture search control unit 102 determines that distillation learning of the architecture coefficient is executed continuously (NO in step S204), the processing in steps S201 to S203 is executed repeatedly.

The processing in step S306 is similar to the processing in step S107 in FIG. 2.

As described above, according to the present exemplary embodiment, applying distillation learning to an architecture coefficient, as well as to a weight coefficient allows search for an architecture with higher performance.

As a modification example of the present exemplary embodiment, the information processing apparatus 100 may sequentially and repeatedly execute the processing in steps S101 to S103 and in steps S301 to S306. In other words, after executing the processing in step S306, the information processing apparatus 100 may execute the architecture search using a hard target by advancing the processing to steps S101 to S103 again.

As a modification example 2 of the present exemplary embodiment, the architecture search control unit 102 may chronologically control whether to execute the weight coefficient distillation learning processing in step S304 and the architecture coefficient distillation learning processing in step S305. The architecture search control unit 102 may determine whether to execute the above-described distillation learning processing at random.

As a modification example 3 of the present exemplary embodiment, the architecture search control unit 102 may chronologically control whether to use a soft target or a hard target for the weight coefficient distillation learning processing in step S304 and the architecture coefficient distillation learning processing in step S305. In the example illustrated in FIG. 13, the architecture search control unit 102 may control whether the second learning on the network model 1205 is executed using a soft target 1206 or a hard target. Similarly, the architecture search control unit 102 may control whether the third learning on the network model 1207 is executed using a soft target 1208 or a hard target.

### Other Exemplary Embodiments

The present disclosure includes a configuration in which programs as software are directly or remotely supplied to a system or an apparatus, so that a computer of the system or the apparatus reads and executes the supplied program codes to achieve the functions according to the above-described exemplary embodiments. In this case, the programs supplied thereto are computer-readable programs corresponding to the flowcharts illustrated in the above-described exemplary embodiments. Further, a computer may carry out the functions according to the above-described exemplary embodiments by executing read programs or by cooperating with an operating system (OS) operating on the computer based on instructions provided by the programs. In this case, the OS executes all or a part of the actual processing, and the functions according to the above-described exemplary embodiments are carried out by that processing.

Disclosure of the above-described exemplary embodiments includes the following configurations and methods.

### (Configuration 1)

An information processing apparatus which executes a search for an architecture of a network model including an architecture coefficient and a weight coefficient includes a first learning unit configured to execute learning of an architecture coefficient with a weight coefficient fixed, a second learning unit configured to execute learning of a weight coefficient with an architecture coefficient fixed, and a control unit configured to execute control to advance the search by causing the first learning unit and the second learning unit to execute learning alternately. The control unit executes control to cause at least any one of the first learning unit and the second learning unit to execute learning on a network model including an architecture coefficient and a weight coefficient acquired at the current point in time using an output value output from a network model set as a teacher model which is configured based on an architecture coefficient and a weight coefficient acquired prior to the current point in time.

### (Configuration 2)

In the information processing apparatus according to Configuration 1, the control unit executes control to cause the second learning unit to execute learning on a network model including an architecture coefficient acquired through first learning using an output value output from the teacher model, after the first learning unit executes the first learning.

### (Configuration 3)

In the information processing apparatus according to Configuration 2, the control unit executes control to cause the first learning to be executed using teacher data set to input data.

### (Configuration 4)

In the information processing apparatus according to Configuration 2 or 3, the control unit sets a network model including an architecture coefficient and a weight coefficient acquired immediately before the first learning as a first teacher model, and executes control to cause the second learning unit to execute learning on a network model including an architecture coefficient acquired through the first learning using an output value output from the first teacher model.

### (Configuration 5)

In the information processing apparatus according to any one of Configurations 2 to 4, the control unit sets a network model including an architecture coefficient acquired through the first learning as a second teacher model, and executes control to cause the first learning unit to execute learning on a network model including a weight coefficient acquired through second learning using an output value output from the second teacher model after the second learning unit executes the second learning using the output value output from the first teacher model.

### (Configuration 6)

In the information processing apparatus according to Configuration 5, the control unit executes control to cause the first learning unit to execute learning on a network model including a weight coefficient acquired through the second learning using an output value output from the second teacher model, or using teacher data set to the input data.

### (Configuration 7)

In the information processing apparatus according to Configuration 5 or 6, the control unit executes control to cause the second learning unit to execute learning on a network model including an architecture coefficient acquired through the first learning using an output value output from the first teacher model, or using teacher data set to the input data.

### (Configuration 8)

In the information processing apparatus according to any one of Configurations 1 to 7, the control unit generates the teacher model using a plurality of architecture coefficients and a plurality of weight coefficients acquired in the course of different searches.

### (Configuration 9)

In the information processing apparatus according to any one of Configurations 1 to 8, the control unit executes control to cause both the first learning unit and the second learning unit to execute learning using teacher data set to input data after at least any one of the first learning unit and the second learning unit executes learning using the output value output from the teacher model.

### (Configuration 10)

In the information processing apparatus according to any one of Configurations 1 to 9, through the control executed by the control unit, the first learning unit acquires a first output value by inputting input data to a network model including an architecture coefficient and a weight coefficient acquired at the current point in time, acquires a second output value by inputting the input data to the teacher model, and executes learning of an architecture coefficient based on a loss calculated from the first output value and the second output value.

### (Configuration 11)

In the information processing apparatus according to any one of Configurations 1 to 10, through the control executed by the control unit, the second learning unit acquires a first output value by inputting input data to a network model including an architecture coefficient and a weight coefficient acquired at the current point in time, acquires a second output value by inputting the input data to the teacher model, and executes learning of a weight coefficient based on a loss calculated from the first output value and the second output value.

### (Configuration 12)

The information processing apparatus according to any one of Configurations 1 to 11 executes a search for an architecture of a network model by using a technique of a neural architecture search (NAS).

### (Configuration 13)

A program which causes a computer to function as respective units of the information processing apparatus according to any one of Configurations 1 to 12.

### (Method 1)

A control method for an information processing apparatus which executes a search for an architecture of a network model including an architecture coefficient and a weight coefficient includes executing learning of an architecture coefficient by first learning with a weight coefficient fixed, executing learning of a weight coefficient by second learning with an architecture coefficient fixed, and executing control to advance the search by causing the first learning and the second learning to execute learning alternately. The controlling executes control to cause at least any one of the first learning and the second learning to execute learning on a network model including an architecture coefficient and a weight coefficient acquired at the current point in time using an output value output from a network model set as a teacher model which is configured based on an architecture coefficient and a weight coefficient acquired prior to the current point in time.

According to the present disclosure, search for an architecture with higher performance can be performed in the course of an architecture search of a network model. Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc ™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-066969, filed Apr. 14, 2022, which is hereby incorporated by reference herein in its entirety.

What is claimed is:

1. An information processing apparatus which executes a search of a network model including an architecture coefficient and a weight coefficient to determine the architecture of the network model, the information processing apparatus comprising:
at least one memory storing instructions; and
at least one processor that, upon execution of the instructions, is configured to:
execute first learning of an architecture coefficient with a weight coefficient fixed;
execute second learning of a weight coefficient with an architecture coefficient fixed; and
execute control to advance the search by causing the first learning and the second learning to execute learning alternately on a network model having an architecture coefficient and a weight coefficient acquired at present time using an output value output from a network model set as a teacher model which is configured based on an architecture coefficient and a weight coefficient acquired before the present time.

2. The information processing apparatus according to claim 1, wherein the at least one processor, upon execution of the instructions, is further configured to execute control to cause the second learning to execute, after the at least one processor executes the first learning, learning on a network model having an architecture coefficient acquired through first learning using an output value output from the teacher model.

3. The information processing apparatus according to claim 2, wherein the at least one processor, upon execution of the instructions, is further configured to execute control to cause the first learning to be executed using, as input data, a teacher data set.

4. The information processing apparatus according to claim 2, wherein the at least one processor, upon execution of the instructions, is further configured to execute control to set a network model having an architecture coefficient and a weight coefficient acquired immediately before the first learning as a first teacher model, and execute control to cause the second learning to execute learning on a network model having an architecture coefficient acquired through the first learning using an output value output from the first teacher model.

5. The information processing apparatus according to claim 4, wherein the at least one processor, upon execution of the instructions, is further configured to execute control to set a network model having an architecture coefficient acquired through the first learning as a second teacher model, and execute control to cause the first learning to execute learning on a network model having a weight coefficient acquired through second learning using an output value output from the second teacher model after the at least one processor executes the second learning using the output value output from the first teacher model.

6. The information processing apparatus according to claim 5, wherein the at least one processor, upon execution of the instructions, is further configured to execute control to cause the first learning to execute learning on a network model having a weight coefficient acquired through the second learning using an output value output from the second teacher model, or using, as input, a teacher data set.

7. The information processing apparatus according to claim 5, wherein the at least one processor, upon execution of the instructions, is further configured to execute control to cause the second learning to execute learning on a network model having an architecture coefficient acquired through the first learning using an output value output from the first teacher model, or using, as the input data, a teacher data set.

8. The information processing apparatus according to claim 1, wherein the at least one processor, upon execution of the instructions, is further configured to execute control to generate the teacher model by using a plurality of architecture coefficients and a plurality of weight coefficients acquired over a course of different searches.

9. The information processing apparatus according to claim 1, wherein the at least one processor, upon execution of the instructions, is further configured to execute control to cause both the first learning and the second learning to execute learning using, as input, a teacher data set after at least one processor executes at least any one of the first learning and the second learning using an output value output from the teacher model.

10. The information processing apparatus according to claim 1, wherein, through the control executed by the at least one processor, the at least one processor, upon execution of the instructions, is further configured to execute the first learning to acquire a first output value by inputting input data to a network model having an architecture coefficient and a weight coefficient acquired at the present time, acquire a second output value by inputting the input data to the teacher model, and execute learning of an architecture coefficient based on a loss calculated from the first output value and the second output value.

11. The information processing apparatus according to claim 1, wherein, through the control executed by the at least one processor, the at least one processor, upon execution of the instructions, is further configured to execute the second learning to acquire a first output value by inputting input data to a network model having an architecture coefficient and a weight coefficient acquired at the present time, acquire a second output value by inputting the input data to the teacher model, and execute learning of a weight coefficient based on a loss calculated from the first output value and the second output value.

12. The information processing apparatus according to claim 1, wherein the information processing apparatus executes a search of a network model by using a technique of a neural architecture search (NAS).

13. A control method for an information processing apparatus which executes a search of a network model including an architecture coefficient and a weight coefficient to determine the architecture of the network model, the control method comprising:
executing first learning of an architecture coefficient by first learning with a weight coefficient fixed;
executing second learning of a weight coefficient by second learning with an architecture coefficient fixed; and
executing control to advance the search by causing the first learning and the second learning to execute learning alternately on a network model having an architecture coefficient and a weight coefficient acquired at present time using an output value output from a network model set as a teacher model which is configured based on an architecture coefficient and a weight coefficient acquired before the present time.

14. A non-transitory computer-readable storage medium storing instructions that when executed by a processor, configure a computer to perform the method comprising:
executing first learning of an architecture coefficient by first learning with a weight coefficient fixed;
executing second learning of a weight coefficient by second learning with an architecture coefficient fixed; and
executing control to advance the search by causing the first learning and the second learning to execute learning alternately on a network model having an architecture coefficient and a weight coefficient acquired at present time using an output value output from a network model set as a teacher model which is configured based on an architecture coefficient and a weight coefficient acquired before the present time.
